(19) United States
(12) Patent Application Publication
(10) Pub. No.: US 2010/0278963 A1
(43) Pub. Date: Nov. 4, 2010

(54) INCLINED EJECTOR MECHANISM AND INJECTION MOLD WITH THE SAME

(76) Inventors: Chien-Yuan Ni, TAIPEI CITY (TW); Chin-Chuan Tsai, TAIPEI CITY (TW); Yuan-Ching Hung, TAIPEI CITY (TW); Hsin-Hsiu Tsai, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/770,701

(22) Filed: Apr. 29, 2010

(30) Foreign Application Priority Data
Apr. 30, 2009 (TW) 098114448

(51) Int. Cl. B29C 45/40

(52) U.S. Cl. 425/556

(57) ABSTRACT

This invention provides an inclined ejector mechanism and an injection mold using the same. The inclined ejector mechanism includes a retaining element, an inclined ejector pin, and an pulling rod. The retaining element has a retaining portion. One end of the inclined ejector pin is operatively connected with the retaining portion, such that the inclined ejector pin is capable of limitedly moving relative to the retaining element. The pulling rod is connected with the retaining element.

### CROSS-REFERENCE TO RELAYED APPLICATIONS

This Non-provisional application claims priority under 35 U.S.C. §119(a) on Patent Application No(s). 098114448 filed in Taiwan, Republic of China on Apr. 30, 2009, the entire contents of which are hereby incorporated by reference.

### BACKGROUND OF THE INVENTION

1. Field of the Invention

This invention relates to an injection mold and, more particularly, to an inclined ejector mechanism and the injection mold with the same.

2. Description of the Related Art

With continuous improvement of modern technology, various kinds of daily articles are also continuously developed. Particularly, components of consuming electronic products are mainly made by a mechanical manufacturing process in which a mold may be used. To finish a manufacturing process of the components, a mold for molding the product needs to be first provided. The mold at least includes a fixed mold and a movable mold. After the fixed mold and the movable mold are closed, a mold cavity is formed therebetween thus to produce the product by injecting a mold material. When the product is to be separated from the fixed mold or the movable mold, a mold-parting mechanism is usually needed to eject the product. The mold-parting mechanism usually is an inclined ejector mechanism for separating the product from the fixed mold or the movable mold.

FIG. 1A is a three-dimensional assembled diagram showing a conventional inclined ejector mechanism 10 applied to an injection mold. FIG. 1B is a three-dimensional exploded diagram showing the inclined ejector mechanism 10 in FIG. 1A. As shown in FIG. 1A and FIG. 1B, the conventional inclined ejector mechanism 10 mainly includes an inclined ejector pin 100 and a pulling rod 102. Particularly, the inclined ejector pin 100 has a sliding groove 1000, and the pulling rod 102 has a sliding structure 1020 correspondingly moving in the sliding groove 1000 of the inclined ejector pin 100. After the sliding structure 1020 of the pulling rod 102 is fastened to the sliding groove 1000 of the inclined ejector pin 100, the pulling rod 102 drives the inclined ejector pin 100 to push or pull in a direction vertical to a sliding direction of the sliding structure 1020 relative to the sliding groove 1000.

FIG. 2 is a sectional diagram showing an injection mold 1 using the inclined ejector mechanism 10 in FIG. 1A. As shown in FIG. 2, the injection mold 1 mainly includes a fixed clamp plate 12, a second mold plate 14, a second mold core 16, a first mold plate 18, a first mold core 20, an ejector plate assembly 22, and a moving clamp plate 24. The injection mold 1 is usually disposed at a supporting base of a molding machine. The inclined ejector mechanism 10 in FIG. 1A is usually disposed in the mold 1 for injection molding for separating an injection molding product from the injection mold 1. The first mold core 20 has an ejector pin hole 200 inclining to a center line C₁ of the mold 1 for injection molding. Further, the first mold plate 18 is disposed under the first mold core 20 and has an ejector hole 180 passing through the first mold plate 18. The ejector hole 180 communicates with the ejector pin hole 200 of the first mold core 20. The ejector plate assembly 22 is disposed under the first mold plate 18. The ejector plate assembly 22 includes a positioning plate 220 and an fixing plate 222 and reciprocates along the center line C₁ of the injection mold 1 relative to the first mold plate 18.

Also as shown in FIG. 2, the inclined ejector pin 100 of the conventional inclined ejector mechanism 10 passes through the ejector hole 180 of the first mold plate 18, such that one end of the inclined ejector pin 100 is disposed in the ejector pin hole 200 of the first mold core 20. Further, one end of the pulling rod 102 is disposed in and fixed to the ejector plate assembly 22, that is, the end of the pulling rod 102 is sandwiched between the positioning plate 220 and the fixing plate 222. To position the inclined ejector mechanism 10 relative to the mold 1 for injection molding, the diameter of the ejector hole 180 needs to precisely fit with that of the ejector pin hole 200. Thereby, the ends of the inclined ejector pin 100 respectively contained in the ejector hole 180 and the ejector pin hole 200 won't be loosened.

In the step of operating the inclined ejector mechanism 10, the ejector plate assembly 22 moves towards the first mold plate 18 along the center line C₁ of the mold 1 for injection molding. At that moment, the pulling rod 102 also push and press towards the first mold plate 18 along the center line C₁ of the mold 1 for injection molding, such that the sliding structure 1020 slides relative to the sliding groove 1000 to drive the inclined ejector pin 100 to slide inclinably in the ejector hole 180 and the ejector pin hole 200. Thereby, the end of the inclined ejector pin 100 pass through the ejector pin hole 200 of the first mold core 20 to successfully separate the injection molding product from the mold 1.

However, when the pulling rod 102 of the inclined ejector mechanism 10 pushes and presses towards the first mold plate 18 along the center line C₁ of the injection mold 1, the inclined ejector pin 100 suffers latitudinal force and longitudinal force at the same time. Usually, the inclined ejector pin 100 is long-shaped. Therefore, the inclined ejector pin 100 is easy to bend and deform after repeatedly used. Thus, the position of the inclined ejector mechanism 10 in the injection mold 1 may be imprecise to affect dimensional precision of the injection molding product. In addition, when the inclined ejector mechanism 10 is to be disassembled or replaced for maintenance, repair or storage, the first mold core 20, the first mold plate 18, and the ejector plate assembly 22 of the injection mold 1 need to be disassembled step by step, such that the inclined ejector pin 100 and the pulling rod 102 of the inclined ejector mechanism 10 is completely removed. During the disassembling process, the injection mold 1 and the inclined ejector mechanism 10 may be damaged mindnessly, and the lifespan of the injection mold 1 and the inclined ejector mechanism 10 may be reduced.

### BRIEF SUMMARY OF THE INVENTION

One objective of this invention is to provide an inclined ejector mechanism. The inclined ejector mechanism includes a retaining element, an inclined ejector pin, and a pulling rod. The retaining element has a retaining portion. One end of the inclined ejector pin is operatively connected with the retaining portion, such that the inclined ejector pin is capable of limitedly moving relative to the retaining element. The pulling rod is connected with the retaining element.

Another objective of this invention is to provide an injection mold. The injection mold includes a first mold base and an inclined ejector mechanism. The first mold base includes a first mold plate, a first mold core, and an ejector plate assembly. The first mold core is disposed at the first mold plate. The inclined ejector mechanism is disposed in the first mold base. The inclined ejector mechanism includes a retaining element, an inclined ejector pin, and a pulling rod. The retaining element is capable of sliding in the first mold plate and is limited between the first mold plate and the first mold core. The retaining element has a retaining portion. The inclined ejector pin is disposed through the first mold plate and the first mold core. One end of the inclined ejector pin is operatively connected with the retaining portion, such that the inclined ejector pin is capable of limitedly moving relative to the retaining element. The pulling rod is disposed through the ejector plate assembly and the first mold plate and is connected with the retaining element. Thereby, when the pulling rod is separated from the retaining element, the retaining element and the inclined ejector pin can be taken out from the first mold base by separating the first mold core from the first mold plate.

Compared with the prior art, according to the inclined ejector mechanism and the injection mold in the invention, geometrical dimensional improvement and an enhanced mechanical design are mainly provided for the inclined ejector mechanism, such that the inclined ejector mechanism reciprocating in the injection mold will reduce friction between components thus to reduce abrasion thereof and to prolong the lifespan. In addition, according to the embodiment of the invention, disassembly and assembly of the inclined ejector mechanism are improved, such that assembling and disassembling procedure of the inclined ejector mechanism is simple and abrasion of the components is also reduced. Thereby, the dimensions of the inclined ejector mechanism is effectively reduced in the invention thus to greatly reduce limitation in designing an injection molding product by skilled persons.

These and other features, aspects, and advantages of the present invention will become better understood with regard to the following description, appended claims, and accompanying drawings.

### BRIEF DESCRIPTION OF THE DRAWINGS

FIG. 1A is a three-dimensional assembled diagram showing a conventional inclined ejector mechanism applied to a injection mold;

FIG. 1B is a three-dimensional exploded diagram showing the inclined ejector mechanism in FIG. 1A;

FIG. 2 is a sectional diagram showing a injection mold using the inclined ejector mechanism in FIG. 1A;

FIG. 3A is a three-dimensional assembled diagram showing an inclined ejector mechanism according to one embodiment of the invention;

FIG. 3B is a three-dimensional exploded diagram showing the inclined ejector mechanism in FIG. 3A; and

FIG. 4 is a sectional diagram showing a injection mold using the inclined ejector mechanism in FIG. 3A.

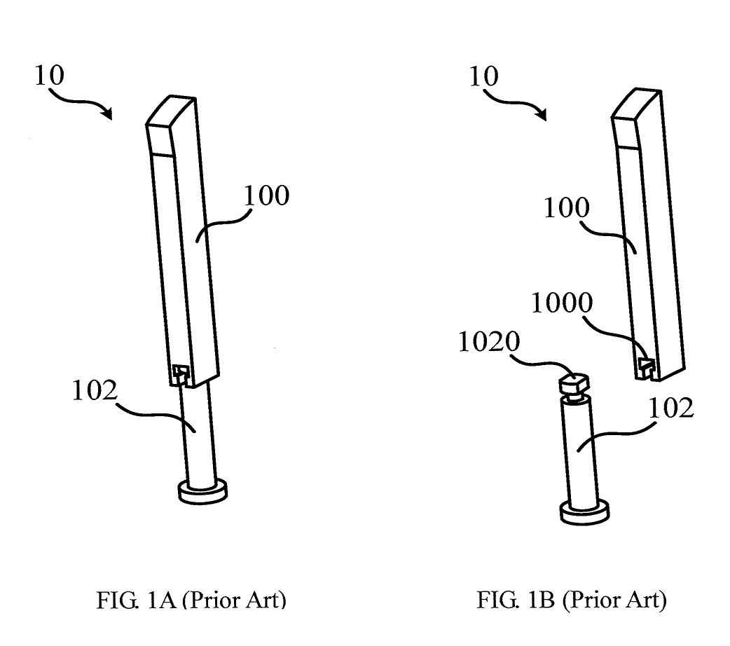

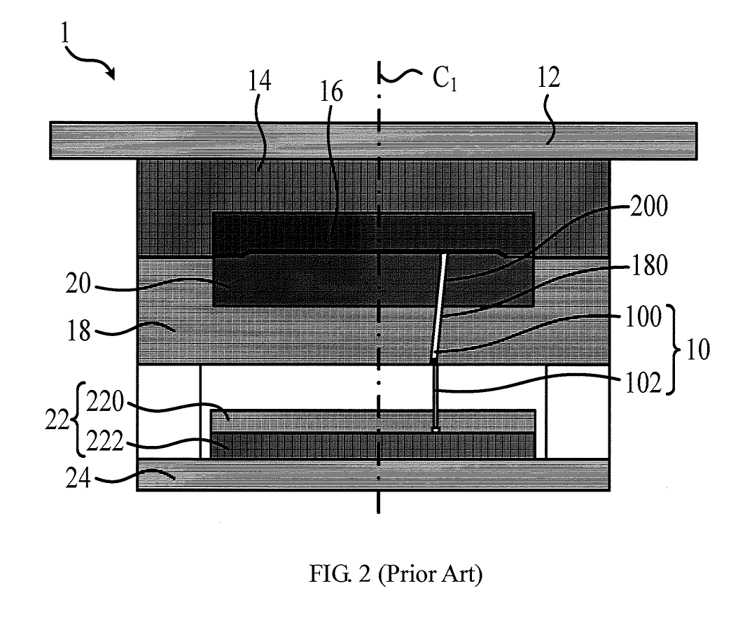

### DETAILED DESCRIPTION OF THE INVENTION

This invention provides an inclined ejector mechanism and an injection mold. More particularly, geometrical dimensional improvement and an enhanced mechanical design are mainly provided for the inclined ejector mechanism, such that the inclined ejector mechanism reciprocating in the injection mold reduces friction between components thus to reduce abrasion thereof and to prolong the lifespan. Preferred embodiments of the invention are described in detail hereinbelow.

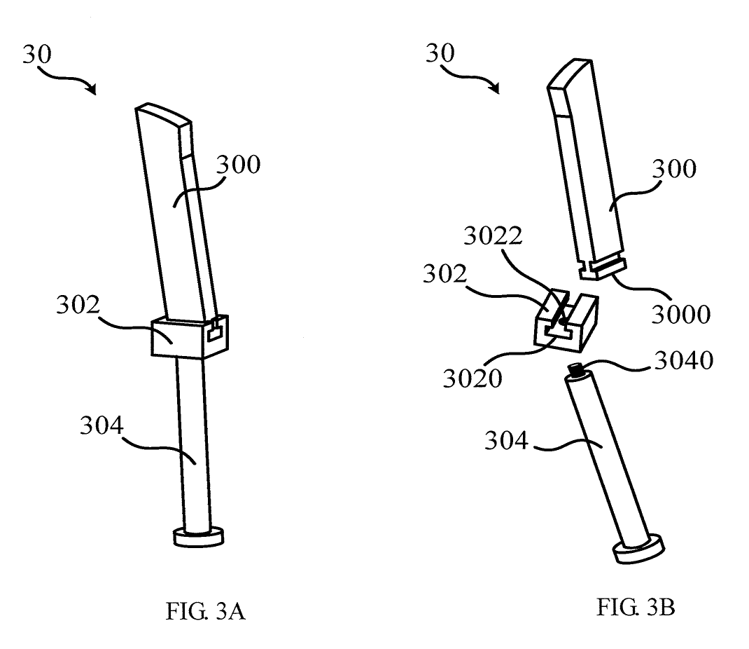

FIG. 3A is a three-dimensional assembled diagram showing an inclined ejector mechanism 30 according to one embodiment of the invention. FIG. 3B is a three-dimensional exploded diagram showing the inclined ejector mechanism 30 in FIG. 3A. As shown in FIG. 3A and FIG. 3B, the inclined ejector mechanism 30 in the embodiment of the invention is applied to a common injection mold. For example, various kinds of molds for injection molding applied to in-mold roller may use the inclined ejector mechanism 30 in the embodiment of the invention to easily reduce abrasion of components to prolong the lifespan. The inclined ejector mechanism 30 in the embodiment of the invention mainly includes a retaining element 302, an inclined ejector pin 300, and a pulling rod 304. The structures, functions, and operating modes of the elements of the inclined ejector mechanism 30 in the embodiment of the invention are described hereinbelow in detail.

As shown in FIG. 3A and FIG. 3B, besides the inclined ejector pin 300 and the pulling rod 304, the inclined ejector mechanism 30 in the embodiment of the invention further includes a retaining element 302. Particularly, the retaining element 302 has a retaining portion. One end of the inclined ejector pin 300 is operatively connected with the retaining portion, such that the inclined ejector pin 300 can limitedly move relative to the retaining element 302. The pulling rod 304 is connected with the retaining element 302.

In one embodiment, the retaining portion of the retaining element 302 is in the form of a sliding groove 3020, and the end of the inclined ejector pin 300 can have a sliding structure 3000 corresponding to the sliding groove 3020 of the retaining element 302, such that the inclined ejector pin 300 slides relative to the retaining element 302. Thereby, after the sliding structure 3000 of the inclined ejector pin 300 is fastened to the sliding groove 3020 of the retaining element 302, the pulling rod 304 drives the inclined ejector pin 300 to push or pull in a direction vertical to a sliding direction of the sliding structure 3000 relative to the sliding groove 3020.

In the conventional inclined ejector mechanism 10, the sliding structure 1020 of the pulling rod 102 slides in the sliding groove 1000 of the inclined ejector pin 100. However, according to the inclined ejector mechanism 30 in the embodiment of the invention, the sliding structure 3000 of the inclined ejector pin 300 slides in the sliding groove 3020 of the retaining element 302. According to experience of using the conventional inclined ejector mechanism 10, after repeatedly used, the sliding groove 1000 of the inclined ejector pin 100 is often seriously damaged, the whole injection mold usually needs to be disassembled and a new inclined ejector pin 100 is needed. Therefore, in the inclined ejector mechanism 30 in the embodiment of the invention, the sliding structure 3000 is disposed at the inclined ejector pin 300, and the sliding groove 3020 is disposed at the retaining element 302. Thereby, a contacting area of a sliding portion of the inclined ejector pin 300, i.e. the sliding structure 3000, is effectively reduced thus to greatly reduce probability of damaging the inclined ejector mechanism 30, to prolong the lifespan, and to be free from complicated procedure for replacing damaged components.

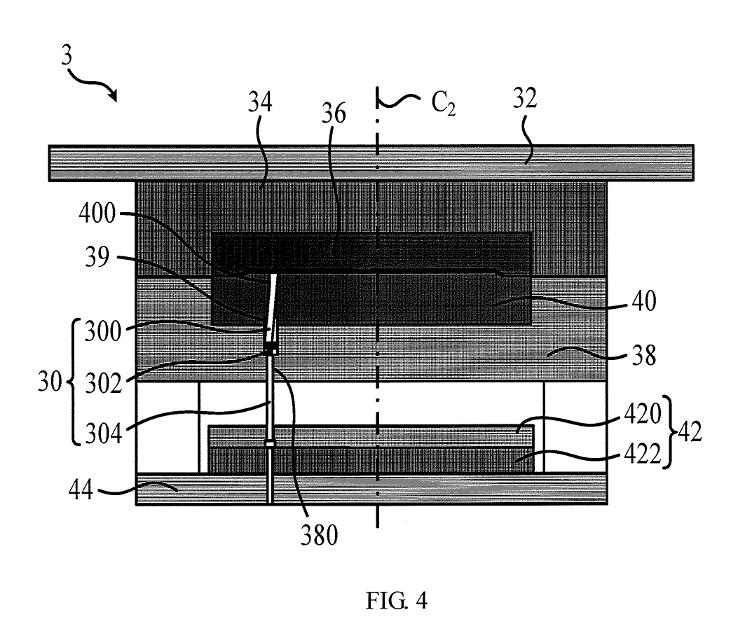

FIG. 4 is a sectional diagram showing the mold 3 for injection molding using the inclined ejector mechanism 30 in FIG. 3A. As shown in FIG. 4, the mold 3 for injection molding mainly includes a fixed clamp plate 32, a second mold base, a first mold base, and a moving clamp plate 44. The second mold base includes a second mold plate 34 and a second mold core 36. The first mold base includes a first mold plate 38, a first mold core 40, and an ejector plate assembly 42. The first mold core 40 is disposed at the first mold plate 38. The mold 3 for injection molding is usually disposed at a supporting base of a molding machine.

The inclined ejector mechanism 30 in FIG. 3A is usually disposed in the mold 3 for injection molding for separating an injection molding product from the mold 3 for injection molding. Exactly speaking, the injection molding product is located between the first mold core 40 and the second mold core 36. The first mold core 40 in the embodiment of the invention has an ejector pin hole 400 inclining to a center line C₂ of the mold 3 for injection molding. Further, the first mold plate 38 is disposed under the first mold core 40 and has an ejector hole 380 passing through the first mold plate 38. The ejector hole 380 communicates with the ejector pin hole 400 of the first mold core 40. The ejector plate assembly 42 is disposed under the first mold plate 38. The ejector plate assembly 42 includes an ejecting inclined ejector pin positioning plate 420 and an ejecting inclined ejector pin fixing plate 422 and can reciprocate along the center line C₂ of the mold 3 for injection molding relative to the first mold plate 38.

Also as shown in FIG. 4, the retaining element 302 in the embodiment of the invention slides in the first mold plate 38 and is limited between the first mold plate 38 and the first mold core 40. Further, the retaining element 302 limitedly slides in a sliding track 39 disposed between the first mold plate 38 and the first mold core 40. The inclined ejector pin 300 of the inclined ejector mechanism 30 in the embodiment of the invention passes through the ejector pin hole 400 of the first mold core 40 and is limited in the sliding track 39 between the first mold plate 38 and the first mold core 40, such that the other end of the inclined ejector pin 300 passes through the ejector pin hole 400 of the first mold core 40 to reciprocate. In addition, the pulling rod 304 in the embodiment of the invention is disposed through the ejector plate assembly 42 and the first mold plate 38, and one end of the pulling rod 304 is disposed in and fixed to the ejector plate assembly 42. The ejector plate assembly 42 further includes the ejecting positioning plate 420 and the fixing plate 422. The pulling rod 304 is disposed through the positioning plate 420. The fixing plate 422 is used for being against the pulling rod 304 thus to limit movement of the pulling rod 304 relative to the positioning plate 420. That is, as shown in FIG. 4, the end of the pulling rod 304 is sandwiched between the positioning plate 420 and the fixing plate 422. To precisely position the inclined ejector mechanism 30 relative to the mold 3 for injection molding, the diameter of the ejector hole 380 needs to precisely fit with that of the inclined ejector pin hole 400. Thereby, the ends of the inclined ejector pin 300 respectively contained in the ejector hole 380 and the ejector pin hole 400 won't be loosened.

In the step of operating the inclined ejector mechanism 30, the ejector plate assembly 42 moves towards the first mold plate 38 along the center line C₂ of the mold 3 for injection molding. At that moment, the pulling rod 304 can also push and press towards the first mold plate 38 along the center line C₂ of the mold 3 for injection molding, such that the sliding structure 3000 of the inclined ejector pin 300 slides relative to the sliding groove 3020 of the retaining element 302 connected with the pulling rod 304 to drive the retaining element 302 to slide along the sliding track 39 and to allow the inclined ejector pin 300 to slide inclinably in the ejector pin hole 400. Thereby, the other end of the inclined ejector pin 300 can pass through the ejector pin hole 400 of the first mold core 40 to successfully separate the injection molding product from the mold 3.

When the conventional inclined ejector mechanism 10 is taken out from the mold 1 for injection molding, the whole mold 1 for injection molding needs to be disassembled. However, when the inclined ejector mechanism 30 in the embodiment of the invention is to be taken out from the mold 3 for injection molding, as long as the first mold core 40 is separated from the first mold plate 38 to take out the first mold core 40 from the mold 3 for injection molding and the pulling rod 304 is separated from the retaining element 302, the retaining element 302 and the inclined ejector pin 300 are taken out together, and the whole mold 3 for injection molding does not need to be disassembled. That is, the first mold base does not need to be completely disassembled, and the pulling rod 304 is left between the ejector plate assembly 42 and the first mold plate 38. Besides saving space, the components can further be prevented from being damaged when the mold is disassembled.

In one embodiment, the retaining element 302 has a screw hole 3022, and one end of the pulling rod 304 have a screw 3040 correspondingly screwed to the screw hole 3022 for connecting the retaining element 302. Certainly, a screw hole may also be disposed at the end of the pulling rod 304, and a screw may correspondingly be disposed at the retaining element 302. However, the invention is not limited thereto. According to particular needs in an actual application or limitation in design, skilled persons in the art choose various kinds of connecting mechanisms to connect the pulling rod 304 and the retaining element 302.

In addition, in one embodiment, the pulling rod 304 and the screw 3040 can be integrally formed.

To sum up, in one embodiment, the other end of the pulling rod 304 sandwiched between the positioning plate 420 and the fixing plate 422 can have a hex socket for fastening a hex screwdriver. Further, the hex screwdriver can pass through the fixing plate 422 to be fastened to the hex socket. However, the invention is not limited thereto. According to particular needs in an actual application or limitation in design, the skilled persons in the art can choose various kinds of fastening mechanisms to be fastened to the other end of the pulling rod 304. Thereby, by rotating the hex screwdriver, the pulling rod 304 can be driven to rotate relative to the retaining element 302 thus to be separated from the retaining element 302. At that moment, the pulling rod 304 is still sandwiched between the positioning plate 420 and the fixing plate 422. Further, the inclined ejector pin 300 and the retaining element 302 can be taken out after the first mold core 40 is separated from the first mold plate 38.

According to the above detailed description about the preferred embodiments of the invention, geometrical dimensional improvement and an enhanced mechanical design are mainly provided for the inclined ejector mechanism, such that the inclined ejector mechanism reciprocating in the injection mold reduces friction between the components thus to reduce abrasion thereof and to prolong the lifespan. In addition, disassembly and assembly of the inclined ejector mechanism are improved, such that assembling and disassembling procedure of the inclined ejector mechanism is simple and abrasion of the components can also be reduced. Thereby, in the embodiments of the invention, the dimensions of the inclined ejector mechanism can be effectively reduced thus to greatly reduce limitation in designing the injection molding product by the skilled persons.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An inclined ejector mechanism disposed in a first mold base, the first mold base including a first mold plate, a first mold core disposed at the first mold plate and an ejector plate assembly, the inclined ejector mechanism comprising:
a retaining element capable of sliding in the first mold plate and being limited between the first mold plate and the first mold core, the retaining element having a retaining portion;
an inclined ejector pin disposed through the first mold plate and the first mold core, one end of the inclined ejector pin being operatively connected with the retaining portion, such that the inclined ejector pin being capable of limitedly moving relative to the retaining element; and
a pulling rod disposed through the ejector plate assembly and the first mold plate and connected with the retaining element,
wherein when the pulling rod is separated from the retaining element, the retaining element and the inclined ejector pin are taken out from the first mold base by separating the first mold core from the first mold plate.

2. The inclined ejector mechanism according to claim 1, wherein the retaining portion is a sliding groove, and the end of the inclined ejector pin has a sliding structure corresponding to the sliding groove, such that the inclined ejector pin is capable of sliding relative to the retaining element.

3. The inclined ejector mechanism according to claim 1, wherein the retaining element has a screw hole, and one end of the pulling rod has a screw correspondingly screwed to the screw hole for connecting the retaining element.

4. The inclined ejector mechanism according to claim 3, wherein the pulling rod and the screw are integrally formed.

5. The inclined ejector mechanism according to claim 3, wherein the other end of the pulling rod has a hex socket for fastening a hex screwdriver.

6. An injection mold comprising:
a first mold base including:
a first mold plate;
a first mold core disposed at the first mold plate; and
an ejector plate assembly; and
an inclined ejector mechanism disposed in the first mold base, the inclined ejector mechanism including:
a retaining element capable of sliding in the first mold plate and being limited between the first mold plate and the first mold core, the retaining element having a retaining portion;
an inclined ejector pin disposed through the first mold plate and the first mold core, one end of the inclined ejector pin being operatively connected with the retaining portion, such that the inclined ejector pin being capable of limitedly moving relative to the retaining element; and
a pulling rod disposed through the ejector plate assembly and the first mold plate and connected with the retaining element,
wherein when the pulling rod is separated from the retaining element, the retaining element and the inclined ejector pin are taken out from the first mold base by separating the first mold core from the first mold plate.

7. The injection mold according to claim 6, wherein the retaining portion is a sliding groove, and the end of the inclined ejector pin has a sliding structure corresponding to the sliding groove, such that the inclined ejector pin is capable of sliding relative to the retaining element.

8. The injection mold according to claim 6, wherein the retaining element has a screw hole, and one end of the pulling rod has a screw correspondingly screwed to the screw hole for connecting the retaining element.

9. The injection mold according to claim 8, wherein the pulling rod and the screw are integrally formed.

10. The injection mold according to claim 8, wherein the other end of the pulling rod has a hex socket for fastening a hex screwdriver.

11. The injection mold according to claim 10, wherein the ejector plate assembly comprises:
an ejecting inclined ejector pin positioning plate, the pulling rod disposed through the ejecting inclined ejector pin positioning plate; and
an ejecting inclined ejector pin fixing plate for being against the pulling rod thus to limit movement of the pulling rod relative to the ejecting inclined ejector pin positioning plate;
wherein the hex screwdriver pass through the ejecting inclined ejector pin fixing plate to be fastened to the hex socket.
